(19) United States
(12) Patent Application Publication
(10) Pub. No.: US 2022/0163432 A1
(43) Pub. Date: May 26, 2022

(54) PROCESS AND DEVICE FOR VAPORIZING PURGE LIQUID FROM A CRYOGENIC LIQUID VAPORIZER

(71) Applicant: L'Air Liquide, Societe Anonyme pour l'Etude et l'Exploitation des Procedes Georges Claude, Paris (FR)

(72) Inventor: Benoit DAVIDIAN, Champigny Sur Marne (FR)

(73) Assignee: L'Air Liquide, Societe Anonyme pour l'Etude et l?Exploitation des Procedes Georges Claude, Paris (FR)

(21) Appl. No.: 17/531,472

(22) Filed: Nov. 19, 2021

(30) Foreign Application Priority Data
Nov. 26, 2020 (FR) FR 2012162

(51) Int. Cl. G01N 1/44; F17C 7/04

(52) U.S. Cl. CPC G01N 1/44; F17C 7/04; F17C 2223/0161; F17C 2265/015; F17C 2221/011; F17C 2227/0302; F17C 2250/0443

(57) ABSTRACT

Process for vaporizing purge liquid from a cryogenic liquid vaporizer, the liquid containing at least one impurity, in which the purge liquid is withdrawn from a bath of liquid surrounding the vaporizer or resulting from the vaporizer, all of the purge liquid is vaporized in a heater, characterized in that the content of the at least one impurity in at least one portion, or even all of the heated vaporized liquid is analysed and the flow rate of at least one portion, or even all of the heated vaporized liquid is measured.

### CROSS REFERENCE TO RELATED APPLICATIONS

This application claims the benefit of priority under 35 U.S.C. § 119 (a) and (h) to French patent application No. FR 2012162, filed Nov. 26, 2020, the entire contents of which are incorporated herein by reference.

### FIELD OF THE INVENTION

The present invention relates to a process and to a device for vaporizing purge liquid from a cryogenic liquid vaporizer.

### BACKGROUND OF THE INVENTION

A cryogenic liquid vaporizer partially vaporizes a liquid containing impurities in order to form a gas. At cryogenic temperatures, some of these impurities are liable to be deposited in the constituent components of the air separation units, in particular in the vaporizer-condenser of the distillation columns. Knowledge of the content of impurities is therefore essential, both in terms of product quality and plant safety.

Such cryogenic liquids, which are usually oxygen, nitrogen or else argon, have a temperature below around −170° C. They are in particular produced by the use of a distillation column belonging to an air separation unit.

It is known to take samples of these cryogenic liquids for the purpose of the subsequent analysis thereof. This then makes it possible to check, in particular, the content of low-volatility impurities in these liquids, such as nitrous oxide N₂O, carbon dioxide CO₂ or hydrocarbons CₙHₘ.

When dealing with the analysis of low-volatility impurities, the difficulty lies in obtaining a vaporized sample at ambient temperature, which is as representative as possible of the liquid to be analysed.

This is because the analytical methods commonly used, such as gas chromatography or infrared spectrometry, involve heating the sample taken to a temperature close to ambient temperature. For this purpose, it is necessary to firstly vaporize the cryogenic liquid sampled, then to heat it.

Under these conditions, in order to result in an analysis representative of a bath of cryogenic liquid, it is advisable, on the one hand, to take therefrom a liquid sample representative of the average composition of the whole of the bath, then to vaporize it rapidly and completely.

In the case of the air separation unit, two cryogenic liquid sampling modes are known in particular.

The first of these, also known as liquid lift, is based on the thermosiphon effect. To achieve this, a by-pass is made for the liquid to be analysed, in which by-pass the flow is provided by the vaporization of a fraction of this liquid.

This liquid lift is diverted to the wall of the cold box of the air separation unit, within an insulated casing, for example insulated by rock wool, in order to limit any heat influx. A continuous sample of the cryogenic liquid flowing in this lift is then vaporized in a finned atmospheric heat exchanger, associated with a mixer, which is commonly called “flash vaporization”.

An alternative mode of sampling, also called capillary sampling, consists in withdrawing the liquid under pressure through a capillary, namely a first tube of small inside diameter, for example about 0.5 mm. This liquid is then conveyed in a second tube, of larger cross section, to a hot spot that ensures an instantaneous vaporization of all of the liquid to be analysed.

These known sampling systems are widespread and guarantee results that are generally satisfactory. However, they do involve certain drawbacks.

Thus, they may lead to a problem of representativeness of the sample taken, in particular as regards the capillary sampling. This is because the latter, if it is connected to a liquid bath, does not allow forced flow of said liquid to be analysed.

Furthermore, these systems are subject to ageing, in particular as regards the liquid lift.

This is because, in the case of the latter, moisture gradually penetrates into the insulation casing, causing the formation and then the build-up of ice. The heat influx then becomes such that the liquid flow may be adversely affected thereby.

### SUMMARY OF THE INVENTION

Under these conditions, the invention proposes to use a process that makes it possible to reliably sample a cryogenic liquid, while using a plant that requires only little maintenance.

FR-A-2839153 describes a process according to the preamble of claim 1 and makes provision for the cryogenic liquid to be vaporized by heat exchange with a hot fluid.

For this purpose, one subject of this invention is a process for sampling at least one cryogenic liquid, notably oxygen or nitrogen, containing impurities such as nitrous oxide, carbon dioxide or hydrocarbons, in which the liquid vaporizes to form a gas, the gas then being sent first to a flowmeter and then to an analyser.

According to one subject of the invention, a process is provided for vaporizing purge liquid from a cryogenic liquid vaporizer, the liquid containing at least one impurity, in which the purge liquid is withdrawn from a bath of liquid surrounding the vaporizer or resulting from the vaporizer, all of the purge liquid is vaporized in a heater, characterized in that the content of the at least one impurity in at least one portion, or even all of the heated vaporized liquid is analysed and the flow rate of at least one portion, or even all of the heated vaporized liquid is measured.

According to some optional aspects:
the content of the at least one impurity in all the heated vaporized liquid is analysed and the flow rate of all the heated vaporized liquid is measured, the analysis sampling being upstream of the measurement of the flow rate;
the vaporizer is in the bottom of a distillation column;
the heated liquid is divided into two portions, the content of the at least one impurity in the first portion is analysed and the flow rate of the second portion is measured;
the first portion constitutes less than 5%, preferentially less than 1%, or even 0.5% of the heated liquid;
the second portion constitutes more than 95%, preferentially greater than 99%, or even 99.5% of the heated liquid;
the cryogenic liquid vaporizer vaporizes the cryogenic liquid in order to produce a gaseous product;
the second portion of the liquid vaporized in the heater is sent to mix with the gaseous product;
a portion of the liquid vaporized in the heater, preferably the flowrate of which has been measured, is sent to mix with the gaseous product; and/or
the gaseous product is heated in a heat exchanger to a temperature above 0° C. and then is mixed with the second portion of the liquid vaporized in the heater.

According to another subject of the invention, a process is provided for separating air by cryogenic distillation comprising a system of columns in which air is cooled and separated in the system of columns in order to produce a cryogenic liquid which is vaporized in a vaporizer, the purge liquid from which is vaporized as described above.

The cryogenic liquid vaporized in the vaporizer may be liquid oxygen.

The cryogenic liquid vaporized in the vaporizer may be an oxygen-enriched liquid containing at least 25 mol % oxygen.

According to another subject of the invention, a device is provided for vaporizing purge liquid from a cryogenic liquid vaporizer, the liquid containing at least one impurity, comprising a cryogenic liquid vaporizer, a line for withdrawing the purge liquid from a bath of liquid surrounding the vaporizer or resulting from the vaporizer, a heater for vaporizing the purge liquid, a flowmeter and an analyser for analysing the content of the at least one impurity of the purge liquid, characterized in that it comprises means for sending at least one portion of the vaporized purge liquid to the analyser in order to analyse the content of at least one impurity and a line for sending at least one portion of the vaporized purge liquid to the flowmeter.

If all the purge liquid is sent to the flowmeter and to the analyser, the means for sending at least one portion of the vaporized purge liquid to the analyser in order to analyse the content of at least one impurity are constituted by the line for sending at least one portion of the vaporized purge liquid to the flowmeter.

Possibly, the device comprises means for sending a first portion of the vaporized purge liquid to the analyser and/or means for sending a second portion of the vaporized purge liquid to the flowmeter.

In this case, preferably, the device does not comprise means for sending the first portion of the vaporized purge liquid to a flowmeter and/or does not comprise means for sending the second portion of the vaporized purge liquid to an analyser.

According to another subject of the invention, a device is provided for separating air by cryogenic distillation comprising a system of columns in order to produce a cryogenic liquid and a device for vaporizing purge liquid as described above, the system of columns being connected to the cryogenic liquid heater.

The system of columns preferably comprises a first column operating at a first pressure and a second column operating at a second pressure, lower than the first pressure.

The device may comprise:
means for withdrawing the purge liquid from the second column that are connected to the heater;
means for withdrawing the bottom liquid from the first column that are connected to the heater.

The purge of liquid from the vaporizer to a double-column cryogenic distillation air separation device represents a small flow, in particular to devices of small size, which is difficult to measure. It is however important to have a precise measurement of this flow, which sets the impurity concentration level in the bath of liquid oxygen, all the more so if the device produces gaseous oxygen directly from the low-pressure column.

The solution according to the prior art is a sampling purge system, which consists in filling then periodically emptying a known volume, over a known duration so as to have the correct purged flow on average. This requires a tank, several valves and instrumentation (level measurement). The instantaneous purge flow is large and in general is “thrown” into a cryogenic purge system. The molecules are not recovered. In certain cases, the purged liquid may be sent to a storage tank, which serves as backup in the event of a failure in the device.

The analysis of the impurities is carried out using a dedicated system of sampling on the bath of cryogenic liquid of the vaporizer, typically of flash vaporization type.

The invention also relates to an air separation device comprising a cryogenic liquid vaporizer and a device for vaporizing purge liquid.

The present invention aims to upgrade the deconcentration purge from a vaporizer in the form of a gas product by combining it with the analysis of the secondary impurities.

The invention consists in rapidly vaporizing the entire liquid purge, to obtain a gas at ambient temperature, easily measure its flow rate and take a gaseous sample to be sent continuously to impurity analysers. The remaining gas is not analysed and is then mixed with the production gas, thus avoiding losing the molecules.

The advantage is to have a reliable, continuous flow rate measurement and to do away with a cryogenic sampling system for measurement of the impurities, which system is expensive, bulky and difficult to install in a vacuum insulated cold box.

### BRIEF DESCRIPTION OF THE DRAWINGS

Further features and advantages of the invention will become apparent from the description hereinafter of embodiments, which are given by way of illustration but without any limitation, the description being given in relation with the following attached figures:

FIG. 1 represents schematically one embodiment according to the invention,

FIG. 2 represents schematically one embodiment according to the invention.

### DETAILED DESCRIPTION OF THE INVENTION

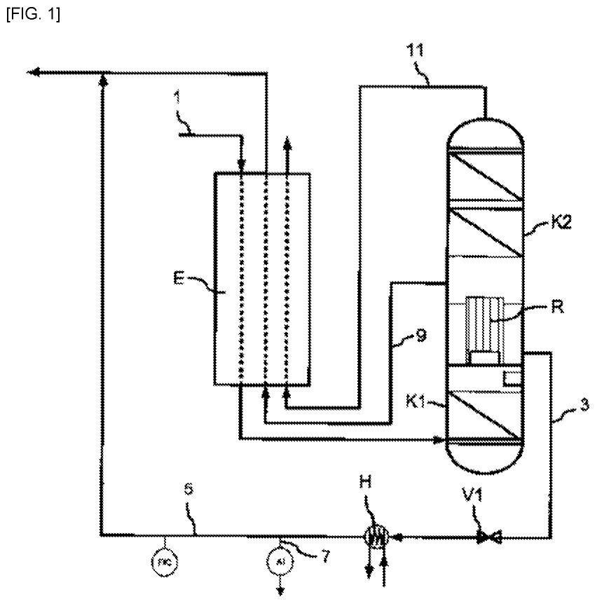

In [FIG. 1] the device for separating air by cryogenic distillation is constituted by a main heat exchanger E and a double column K1, K2, inside one or more insulated chambers, for example a vacuum insulated cold box, enabling operation at cryogenic temperatures.

The double column comprises a first column K1, surmounted by a second column K2 operating at a lower pressure than the first column.

Air 1 is cooled in the exchanger E and is sent to the bottom of the first column K1 where it is separated by distillation. An oxygen-enriched flow is sent from the bottom of the first column K1 an intermediate point of the column K2. A nitrogen-enriched flow is sent from the top of the first column Kl to the second column K2.

The nitrogen from the top of the first column is condensed in the vaporizer-condenser R at the bottom of the second column where it is used to vaporize the bottom liquid of the second column which surrounds the vaporizer R. A flow of gaseous oxygen 9 constituting a, or even the, product of the device is withdrawn from the second column and is heated in the exchanger E. Gaseous nitrogen 11 from the top of the second column is heated in the exchanger E.

The vaporizer R represented here is a conventional bath vaporizer and the purge of which is withdrawn from the bath. Conversely, the vaporizer R may be a film vaporizer where the “bath” of liquid is under the vaporizer or else a so-called bath vaporizer but with a built-in tank or else a recirculation pipe, without a true bath in the conventional sense.

Thus it is possible to withdraw the purge liquid from a bath of liquid surrounding the vaporizer or resulting from the vaporizer.

The purge 3 from the bath of liquid oxygen here surrounding the vaporizer R is withdrawn continually at the bottom of the bath. It is then vaporized “abruptly” (flash vaporization) against a fluid which ensures a high wall temperature (such that ΔT between the purge liquid and the fluid is greater than 100° C.) so as to avoid a high local concentration of secondary impurities (CₙHₘ, CO₂, N₂O) which is dangerous for safety in a heater H. This also makes it possible to ensure that all of the impurities present in the liquid purge are present in the gas thus formed, which will make it possible to have a reliable analysis of the impurities (thus there are no impurities deposited in the heater H which would skew the analysis). It is then heated in gaseous form up to ambient temperature in the heater H.

The heat exchange in the heater H can be carried out against ambient air in an atmospheric vaporization hairpin, against water in a shell and tube exchanger, or preferentially an exchanger with a shell and spiral tubes or else coaxial spiral tubes. The exchanger may also comprise spiral tubes for the purge and for water, with everything embedded in an aluminium or copper matrix. The exchanger may also comprise electric heating.

The heater H may be located outside of any insulated chamber.

The walls of the heater H intended to come into contact with the or each cryogenic liquid 3 are maintained at a temperature at least 15° C., preferably at least 50° C., or even at least 100° C. above the temperature of the purge liquid so that the vaporized liquid is heated up to at least −50° C., or even at least −20° C., preferably at least 0° C.

In order to do this, the fluid heating the heater H must generally be at least 100° C. hotter than the cryogenic liquid.

The temperature of the walls of the heater is preferably also greater than the sublimation or vaporization temperature of the least volatile impurity contained in the cryogenic liquid.

A small flow 7 is sampled from the purge 3 for example at most 5% of the purge, preferentially less than 1%, or 0.5% of the purge and this flow is sent via a pipe of several metres in length to the analysers of impurities which analyse them at ambient temperature, i.e. at at least 0° C. The total vaporization of the purge 3 makes it possible to measure its flow in a reliable manner (since it is a gaseous flow which is at ambient temperature). The separation due to the sampling is carried out upstream of the flow measurement. The small sampling flow disturbs only marginally and in a safe manner (upper value) the measurement of the purge flow 3. Alternatively, the separation may be carried out downstream of the flow measurement.

It is then easy to measure the remaining gaseous purge 5 constituting at least 95% of the purge, preferentially greater than 99%, or even 99.5% of the purge at ambient temperature in a flow measurement means FIC, for example by a simple orifice plate or a hot-wire mass flowmeter. This measurement means FIC lies outside of the chamber, just like the heater H, since the flow measurement is carried out at ambient temperature.

The heated purge 5 is then remixed with the production of gaseous oxygen 9, at the hot end of the exchanger E, which makes it possible to increase the production by a few percent, typically around 1%.

The purge flow 3 is sent throughout the operation of the device to the heater H through the open valve V1. The valve V1 regulates the purge flow owing to the FIC flow measurement.

The invention makes it possible to minimize the number of components for managing the purge continuously and more reliably, and its compactness/simplicity enables it to be easily integrated into a vacuum insulated cold box.

The device may comprise a turbine (not shown in FIG. 1) to keep the device cold. In the case of a vacuum cold box, the body of the turbine may be directly welded to the shell of the cold box, which makes it possible to achieve better compactness and ensures the leaktightness with respect to the vacuum. The internals of the turbine, commonly referred to as cartridge, may be removed from the outside, without going into the vacuum cold box, for example to change the wheel in the case of breakage of the machine. Similarly, a filter may be positioned at the suction end of the turbine to protect the wheel. It is also advantageous to provide it integrated into the cartridge or into the body of the turbine, while being accessible from the outside in order to be able to change it or clean it.

Furthermore, to achieve better compactness, the cryogenic valves may have their bodies installed in the vacuum cold box and have their extension pass-through welded to the wall of the cold box, optionally through a flange and/or bellows positioned between the extension pass-through and the shell of the vacuum cold box.

The turbine and the valves may be installed in a part of the cold box which has a reduced diameter compared to the rest of the cold box, so as to place these pieces of equipment in the “shade” of the cold box, without this impinging for example on the transport size.

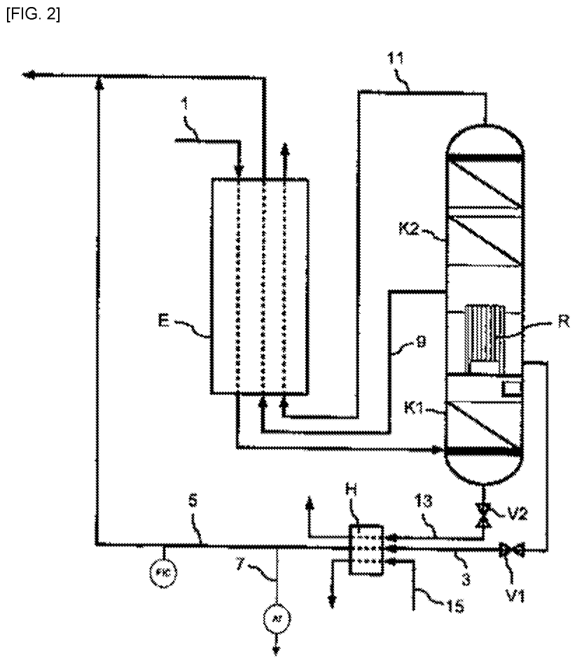

Furthermore, during the prolonged shutdown of the device, it is necessary to purge all of the cryogenic liquids, sent in general to an external storage tank where the liquids vaporize slowly. This storage tank is of large size and is therefore expensive. It is possible to add this function to the exchanger H used to vaporize the continuous purge from the vaporizer R, by oversizing it: this makes it possible to have a device which does not discharge any cryogenic liquid, therefore without having to deal with the associated safety problems.

[FIG. 2] shows a modified version of the device from the preceding figure where the heater H is used to vaporize, in addition to the purge liquid, the bottom liquid of the first column K1. Specifically, during the shutdown of a device, the liquids descend through the column and accumulate in the bottom. In order to start the column if the level is too high or if it is desired to carry out a deicing of the device by sending a gas at ambient temperature in order to completely heat the device, it is necessary to remove the bottom liquid and this bottom liquid is generally sent to a dedicated heat exchanger where it is vaporised before being sent to the atmosphere or any other purge system, for example an external storage tank where the liquids vaporize slowly. Here the exchanger H is used, during the normal operation of the device, to vaporize the purge liquid 3, the valve V1 being open and the valve V2 closed.

After a shutdown and before restarting or a deicing, the valve V2 is opened to enable the bottom liquid to pass through the line 13 to the heat exchanger H.

The source of heat for vaporizing the two liquids at different periods may be electricity or a fluid 15 present on the site, such as air or water.

The bottom liquid is thus vaporized and sent into the air.

In the figure, the bottom liquid is the one from the first column K1 but it may originate from another column, for example K2 or an argon column.

In the figures, the liquid vaporized and heated in the exchanger H is divided into two portions, only the portion 7 being analysed and only the portion 5 passing through the flowmeter FIC. Thus the portion 5 is not analysed and the flow rate of the portion 7 is not measured.

It is also possible not to separate the heated liquid and analyse the whole flow and also measure the whole flow. In this case, it is preferable to place the analysis sampling point upstream of the flowmeter in order to ensure that the pressure in the analyser is high enough.

In order to reduce the footprint and increase the hydrostatic pressure of the purge liquid arriving at the heat exchanger H, this exchanger is placed beneath the first column K1 and preferably beneath the chamber that contains the columns Kl, K2. It is possible to place the heat exchanger E between the bottom of the column K1 and the exchanger H.

For both figures, the column K1 operates between 1.2 and 6.5 bar, preferably between 1.2 and 4.5 bar.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed.

Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

I claim:

1. A process for vaporizing purge liquid from a cryogenic liquid vaporizer, the liquid containing at least one impurity, the process comprising the steps of:
withdrawing the purge liquid from a bath of liquid surrounding the vaporizer or resulting from the vaporizer;
vaporizing all of the purge liquid in a heater;
analyzing the content of the at least one impurity in at least one portion of the heated vaporized liquid; and
measuring the flow rate of at least one portion of the heated vaporized liquid.

2. The process according to claim 1, wherein the content of the at least one impurity in all the heated vaporized liquid is analysed and the flow rate of all the heated vaporized liquid is measured, the analysis sampling being upstream of the measurement of the flow rate.

3. The process according to claim 1, wherein the liquid heated to at least −50° C. is divided into two portions, the content of the at least one impurity in the first portion is analysed and the flow rate of the second portion is measured.

4. The process according to claim 3, wherein the first portion constitutes at most 5% of the vaporized liquid.

5. The process according to claim 3, wherein the first portion constitutes less than 1% of the vaporized liquid.

6. The process according to claim 3, wherein the first portion constitutes less than 0.5% of the vaporized liquid.

7. The process according to claim 1, wherein the cryogenic liquid vaporizer vaporizes cryogenic liquid in order to produce a gaseous product, at least one portion of the liquid vaporized in the heater being sent to mix with the gaseous product.

8. The process according to claim 7, wherein at least one portion of the liquid vaporized in the heater is the second portion.

9. The process according to claim 7, wherein the first portion constitutes at most 5% of the vaporized liquid, in which the gaseous product is heated in a heat exchanger to a temperature above 0° C. and then is mixed with the second portion of the liquid vaporized in the heater.

10. The process according to claim 1, where the cryogenic liquid vaporized in the vaporizer is liquid oxygen or an oxygen-enriched liquid containing at least 25 mol % oxygen.

11. A process for separating air by cryogenic distillation comprising a system of columns in which air is cooled and separated in the system of columns in order to produce a cryogenic liquid which is vaporized in a vaporizer, wherein the purge liquid from which is vaporized according claim 1.

12. A device for vaporizing purge liquid from a cryogenic liquid vaporizer, the liquid containing at least one impurity, the device comprising:
a cryogenic liquid vaporizer;
a line for withdrawing the purge liquid from a bath of liquid surrounding the vaporizer or resulting from the vaporizer;
a heater configured to vaporize the purge liquid;
a flowmeter and an analyser configured to measure and analyze the content of the at least one impurity of the purge liquid;
means for sending at least one portion of the vaporized purge liquid to the analyser in order to analyse the content of at least one impurity; and
a line for sending at least one portion of the vaporized purge liquid to the flowmeter.

13. The device according to claim 12, further comprising means for sending a first portion of the vaporized purge liquid to the analyser and/or means for sending a second portion of the vaporized purge liquid to the flowmeter.

14. The device according to claim 12, further comprising an absence of means for sending a/the first portion of the vaporized purge liquid to a flowmeter.

15. The device according to claim 12, further comprising an absence of means for sending the second portion of the vaporized purge liquid to an analyser.

16. The device according to claim 12, further comprising an air separation unit comprising a system of columns in order to produce a cryogenic liquid that is in fluid communication with the device for vaporizing purge liquid, the system of columns being connected to the cryogenic liquid heater in order to send thereto a bottom liquid from a column of the system of columns, the device comprising means for withdrawing the purge liquid from the second column and the bottom liquid from the first column.

17. The device according to claim 16, wherein the system of columns comprises a first column operating at a first pressure and a second column operating at a second pressure, lower than the first pressure.
